(19) United States
(12) Patent Application Publication
(10) Pub. No.: US 2026/0032575 A1
(43) Pub. Date: Jan. 29, 2026

(54) SELECTION OF ACCESS POINT MULTI-LINK DEVICE

(71) Applicant: HEWLETT PACKARD ENTERPRISE DEVELOPMENT LP, Spring, TX (US)

(72) Inventors: Xuguang Jia, Beijing (CN); Xiaoyang Fu, Beijing (CN); Qiang Zhou, Sunnyvale, CA (US)

(21) Appl. No.: 18/784,086

(22) Filed: Jul. 25, 2024

(51) Int. Cl. H04W 48/20; H04B 17/318

(52) U.S. Cl. CPC H04W 48/20; H04B 17/318

(57) ABSTRACT

In implementations of the present disclosure, a solution for selecting an access point (AP) among a plurality of candidate APs is provided. A station (STA) MLD determines active links of a plurality of AP MLDs, and obtains physical information and media access control (MAC) information of the active links based on scanning the active links. The STA MLD further determines a plurality of received signal strength indicators (RSSIs) of the active links for a period of time, and determines a plurality of path costs for the active links based on the plurality of RSSIs, the physical information, and the MAC information. Then, the STA MLD selects an AP MLD from the plurality of AP MLDs based on the plurality of path costs. In this way, the AP MLD quality assessment approach and the evaluation model can be enhanced.

### BACKGROUND

In the field of Wi-Fi, Wi-Fi 7 (i.e., Institute of Electrical and Electronics Engineers (IEEE) 802.11be) is a Wi-Fi standard. In Wi-Fi 7, a station (STA) multi-link device (MLD) is able to transmit and receive data over multiple links at the same time, thereby improving network throughput, reducing latency, and enhancing the reliability of data transmission. An STA MLD can be an access point (AP) MLD (each attached STA is an AP) or a non-AP MLD (each attached STA is a non-AP STA). Further, an STA MLD does not necessarily always require multiple links on multiple frequency bands (such as 2.4 gigahertz (GHz), 5 GHZ, and 6 GHz). Wi-Fi 7 supports single-link/single-radio non-AP MLD, which allows operation on multiple links, but only receives or transmits frames on one link at a time.

In Wi-Fi 7, a received signal strength indicator (RSSI) refers to a measure of the strength of the wireless signal at the receiver side. The RSSI is an important parameter used by network administrators and users to evaluate the signal quality of wireless networks. The higher the RSSI value, the stronger the received wireless signal and the more stable the network connection may be. On the contrary, if the RSSI value is low, it may mean that the signal is weak and the connection may be unstable or susceptible to interference. In Wi-Fi 7, signal strength information such as RSSI may be used to optimize multi-link operation (MLO) and other advanced features to ensure better network performance in different environments.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example network environment in which example implementations of the present disclosure may be implemented;

FIG. 2 illustrates an example MLD parameter subfield format;

FIG. 3 illustrates an example diagram of STA MLD discovery optimization for single-radio according to implementations of the present disclosure;

FIG. 4 illustrates an example diagram of STA MLD discovery optimization for multi-radio according to implementations of the present disclosure;

FIG. 5 illustrates an example diagram of obtaining RSSI information via channel scanning according to implementations of the present disclosure;

FIG. 6 illustrates an example basic service set (BSS) load element format;

FIG. 7 illustrates an example flow chart of an example method for selecting an AP according to implementations of the present disclosure; and

FIG. 8 illustrates an example STA MLD according to implementations of the present disclosure.

### DETAILED DESCRIPTION

In prior iterations of Wi-Fi, such as Wi-Fi 5 and Wi-Fi 6, devices were restricted to connecting to a single Wi-Fi band at a moment, for instance, either the 2.4 GHz or the 5 GHz band. Even later advancements, including Wi-Fi 6E devices, connectivity extends to the 6 GHz band but maintains the limitation of connecting to only one band at a time. To illustrate, a conventional Wi-Fi 6 router can operate across both the 2.4 GHz and 5 GHz bands. However, a smartphone is only able to establish a connection over one of these bands at a time. Consequently, the unused band is left idle, or the connection speed is reduced by selecting the slower band.

Wi-Fi 7 with the MLO technology can aggregate multiple channels on different frequency bands at the same time, which can negotiate seamless network traffic even if there is interference or congestion. With the MLO, Wi-Fi 7 can establish multiple links between an STA and an AP. Connecting to the 2.4 GHz, 5 GHz, and 6 GHz bands simultaneously can increase the throughput, reduce the latency, and improve reliability. Only for the purpose of brevity, an AP, an STA, and a client in the present disclosure hereafter referred to as an MLD which supports the MLO feature if there is no contrary description. For example, an access point hereafter may be referred to as an AP MLD, which supports the MLO feature. Further, in the context of the present disclosure hereafter, an STA MLD only comprises non-AP MLD.

Traditionally, for an STA MLD, the main method to select the best neighbor AP is based on RSSI. The RSSI can be derived from signal-to-noise ratio (SNR) and/or noise figure (NF) measurements for beacon and/or probe responses. However, this simplistic RSSI-based assessment method is not suitable for wireless quality assessment on Wi-Fi 7 STA MLD for three main reasons. The first reason is that Wi-Fi 802.11 standard does not define the criteria or the guideline for a non-AP MLD (i.e., STA MLD in the present disclosure) to select the best AP MLD, and it all depends on each vendor's design. The second reason is that a STA MLD has multiple links, and each link has different RSSIs, transmission (Tx) powers, channel utilities and loads, and when the STA-MLD tries to find the best candidate AP, all links should be accounted, and thus how to detect and assess every links' parameters is a big challenge for the STA MLD. The third reason is that the traditional STA channel scanning scheme is inefficient for an STA MLD because it needs to scan all valid channels on each working band of the AP MLDs' links.

Therefore, implementations of the present disclosure propose a solution for selecting an AP among a plurality of candidate APs. Generally, A STA MLD determines active links of a plurality of AP MLDs, and obtains physical information and media access control (MAC) information of the active links based on scanning the active links. The STA MLD further determines a plurality of RSSIs of the active links for a period of time, and determines a plurality of path costs for the active links based on the plurality of RSSIs, the physical information, and the MAC information. Finally, the STA MLD selects an AP MLD from the plurality of AP MLDs based on the plurality of path costs.

According to implementations of the present disclosure, when selecting the best candidate AP MLD, more factors, for example, the RSSIs, the physical information, and the MAC information, can be accounted when the STA MLD tries to find the best candidate AP. In this way, the AP MLD quality assessment approach and the evaluation model can be enhanced, and thus it can improve the efficiency and accuracy of an STA MLD to evaluate the quality of neighbor AP MLDs.

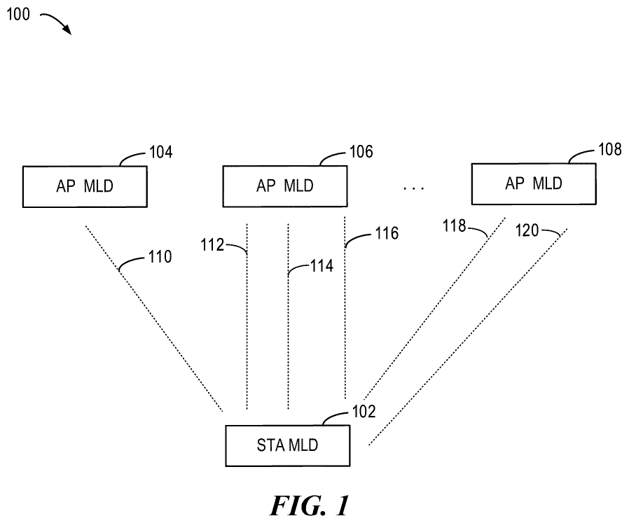

The advantages of implementations of the present disclosure will be described with reference to example implementations as described below. Reference is made below to FIG. 1 through FIG. 8 to illustrate basic principles and several example implementations of the present disclosure herein.

Reference is made to FIG. 1, which illustrates an example network environment 100 in which example implementations of the present disclosure may be implemented. As shown in FIG. 1, the network environment 100 may comprise an STA MLD 102, an AP MLD 104, an AP MLD 106, and an AP MLD 108. Any of the AP MLD 104, the AP MLD 106, and the AP MLD 108 may operate on the 2.4 GHz band. Any of the AP MLD 104, the AP MLD 106, and the AP MLD 108 may further operate on the 5 GHz band. Any of the AP MLD 104, the AP MLD 106, and the AP MLD 108 may further operate on the 6 GHz band. The STA MLD 102 may operate on the 2.4 GHz band. The STA MLD 102 may further operate on the 5 GHz band and the 6 GHz band as well as any of the AP MLD 104, the AP MLD 106, and the AP MLD 108.

The network environment 100 may further comprise one link, two links, or three links between each AP MLD and the STA MLD 102. For example, these links may include a link 110 between the AP MLD 104 and the STA MLD 102 as shown in FIG. 1. The link 110 may operate on the 2.4 GHz frequency band.

For another example, these links may further include a link 112, a link 114, and a link 116 between the AP MLD 106 and the STA MLD 102 as shown in FIG. 1. The link 112 may operate on the 2.4 GHz frequency band. The link 114 may operate on the 5 GHz frequency band, and the link 116 may operate on the 6 GHz frequency band.

For a further example, these links may further include a link 118 and a link 120 between the AP MLD 108 and the STA MLD 102 as shown in FIG. 1. The link 118 may operate on the 5 GHz frequency band, and the link 120 may operate on the 6 GHz frequency band.

Further, it is to be understood that the number of AP MLDs, the number of the STA MLDs, the number of the links are not limited to what they are shown in FIG. 1. The layout and arrangement of the STA MLD and the AP MLDs are not limited to what they are shown in FIG. 1. It is to be understood that for the purposed of simplification, the term “link” and the term “band” may be used interchangeably throughout the present disclosure.

In the network environment 100, the STA MLD 102 may be a multi-link multi-radio device, which means it can receive or transmit frames via multiple links at the same time. The STA MLD 102 may also be a multi-link single radio (MLSR) device, which means it has multiple links, but it receives or transmits frames on a single link at a time.

The STA MLD 102 may assess the surrounding AP MLDs to choose an AP MLD with the best channel quality, the most stable signals, the fastest speed, the best channel utility, or the like (can be collectively referred to as performance). For example, the STA MLD 102 may select the AP MLD 104 as the best candidate AP MLD to be connected to. The factors for assessing an AP MLD in Wi-Fi 7 are more than Wi-Fi 6 because there is more than one link that can be used for data transmission at a time. When the STA MLD 102 tries to find out the best candidate AP, all links should be considered. Moreover, because there are more links, which means more channels, the time for channel discovery should be more efficient for time saving.

In some example implementations, the STA MLD 102 may obtain the basic link information of the neighbor AP MLD, for example, the AP MLD 104, the AP MLD 106 and the AP MLD 108, from beacon/probe respond frames via a passive scanning process (for example, listening beacons or probe frames on the links) on all the links comprising the link 110, the link 112, the link 114, the link 116, the link 118 and the link 120. Then, the STA MLD 102 may establish a candidate table. The candidate table may comprise each AP MLD and its corresponding working channel/band information. For example, AP MLD 104 may have channel A on the link 110, The AP MLD 106 may have channel B on the link 112, and the AP MLD 106 may have channel C on the link 114, and the AP MLD 106 may have channel D on the link 116. The AP MLD 108 may have channel E on the link 118, and the AP MLD 108 may have channel F on the link 120. It is to be understood that there could be more channels on a link.

In some example implementations, the STA MLD 102 may create another candidate table for scanning. The other candidate table may comprise the link/band and its corresponding channels and its corresponding AP MLDs. For example, the 2.4 GHz band (the link 110 and the link 112) may have channel A and channel B. The 5 GHz band (the link 114 and the link 118) may have channel C and channel E. The 6 GHz band (the link 116 and the link 120) may have channel D and channel F.

Then, the STA MLD 102 may obtain and verify complete information on all AP MLDs' MAC information and physical information via an active scanning process. The STA MLD 102 may send multi-link (ML) probe request frame on the links to obtain and verify the whole ML information.

The STA MLD 102 may double-check the status of each link. The STA MLD 102 may need to scan the other links to cross-check if this link actual exists even though it may know this link information from a reduced neighbor report (RNR) and per-STA profile information from an ML probe. The STA MLD 102 may obtain RSSI information via a periodic scanning process on per-link for each of the AP MLD 104, the AP MLD 106, and the AP MLD 108.

After obtaining the MAC information, the physical information, and the RSSI information on each active channel of the active links, the STA MLD 102 may compute a metric of each AP MLD that considers the above factors as a whole. This metric may be called the path cost herein. Usually, the AP MLD with the smallest path cost may be selected as the best candidate AP MLD. In this way, the efficiency and accuracy of an STA MLD to evaluate the quality of neighbor AP MLDs can be improved.

It is to be understood that in FIG. 1 and throughout the present disclosure, the number of any elements is only for the purpose of illustration without suggesting any limitations. The network environment 100 may comprise more or fewer links, and the AP MLD 104, the AP MLD 106, the AP MLD 108, and the STA MLD 102 may support more links as Wi-Fi technology develops in the future.

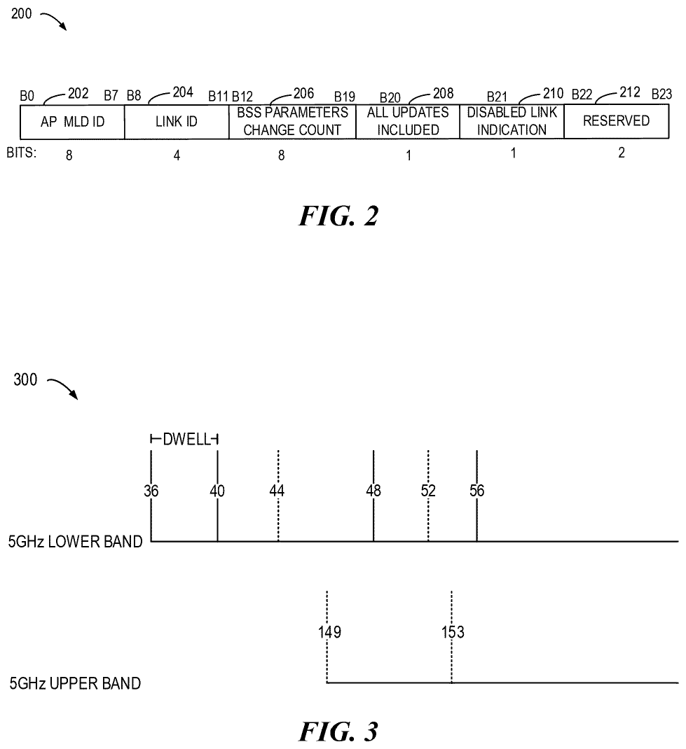

Reference is made to FIG. 2, which illustrates an example MLD parameter subfield format 200. The MLD Parameter subfield is a component of the target beacon transmission time (TBTT) Information field within the RNR element in IEEE 802.11 wireless communication standards. It is used to convey information about the MLD and its associated Aps, AP MLDs, STAs, or STA MLDs. For the purpose of better description, FIG. 2 will be described with reference to FIG. 1.

In some example implementations, the STA MLD 102 may obtain the basic link information of all its neighbor AP MLDs 104, 106, and 108 from MLD parameters in RNR information element (IE) from Beacon/Probe respond frames via a passive scanning process on all the links 110, 112, 114, 116, 118 and 120. In some example implementations, the STA MLD 102 may obtain the basic link information of all its neighbor AP MLDs 104, 106, and 108 from MLD parameters in the per-STA profile information in ML IE from Beacon/Probe respond frames via the passive scanning process.

As shown in FIG. 2, the example MLD parameter subfield format 200 may be included in an RNR element. The RNR element may comprise the MLD link identifier (ID) information. This MLD link ID information can be used for mapping the relationship between the MLD link information and the related channel information. As shown in FIG. 2, the block 202, starting from BC and ending at B7 and occupying 8 bits, represents the field of AP MLD ID. The block 204, starting from B8 and ending at B11 and occupying 4 bits, represents the field of link ID. The block 206, starting from B12 and ending at B19 and occupying 8 bits, represents the field of the count of BSS parameters change. The block 208, starting from B20 and occupying 1 bit, represents the field of all the updates included. For example, the field of all updates included is useful for all the cases where the BSS parameters count change got incremented and the corresponding updates are included. If an MLD of a non-AP MLD missed the beacon frame, it will check the BSS parameters count change fields of the APs of the associated AP MLD to see if it missed an update and if the field of all updates included is also set to 1, it will know that the updates are included.

The block 210, starting from B21 and occupying 1 bit, represents the field of disabled link indication. The block 212, starting from B22 and ending at B23 and occupying 2 bit, represents the reserved field. Therefore, the STA MLD 102 would know the basic link information of all its neighbor AP MLDs 104, 106, and 108 from MLD parameters in RNR information element (IE) via the passive scanning process on all the links 110, 112, 114, 116, 118 and 120. The MLD parameters in the per-STA profile information in the ML IE from the Beacon/Probe respond frames can be obtained in a similar manner. For the purpose of simplification, it will not be described in detail.

After obtaining basic link information of the AP MLDs 104, 106, and 108, the STA MLD 102 may create a candidate table for further scanning as shown in Table 1.

TABLE 1
candidate table

| | Channel information | | | | | |
|---|---|---|---|---|---|---|
| Neighbor AP | Link | Link | Link | Link | Link | Link |
| MLD list | 110 | 112 | 114 | 116 | 118 | 120 |
| AP MLD 104 | A | | | | | |
| AP MLD 106 | | B | C | | | |
| AP MLD 108 | | | | D | E | F |

Considering the link 110 and the link 112 both represent the 2.4 GHz link, and the link 114 and the link 118 both represent the 5 GHz link, and the link 116 and the link 120 both represent the 6 GHz link, Table 1 can be generalized as Table 2.

TABLE 2
generalized candidate table

| | Channel information | | |
|---|---|---|---|
| Neighbor AP MLD list | Link 1 | . . . | Link N |
| Neighbor AP MLD 1 | A | . . . | X |
| . . . | . . . | . . . | . . . |
| Neighbor AP MLD N | C | . . . | Z |

in which each number of 1 to N represents an identifier of a frequency band, and each letter of A to Z represents an identifier of an AP MLD or a link.

For the supported Wi-Fi band (herein 2.4 GHz, 5 GHz, and 6 GHZ are used as examples), the active AP MLD number for each of the active link on all the neighbor AP MLDs can be obtained by scanning according to candidate Table 1. Then, the STA MLD 102 may scan a candidate Table 3, and the candidate Table 3 may guide the STA MLD 102 to pick proper scanning parameters (such as a frequency band, a channel number, a dwell time, and/or a scanning time) to accelerate the AP MLD discovery process.

The candidate Table 3 may be obtained based on the candidate Table 1, and it can be considered as another formation of the candidate Table 1 from a different angle. Example of the candidate Table 3 may be shown below.

TABLE 3
candidate table

| Link/Band | Channel information | Active AP MLD list/number |
|---|---|---|
| 2.4G | A | 104 |
| | B | 106 |
| 5G | C | 106 |
| | E | 108 |
| 6G | D | 106 |
| | F | 108 |

In some example implementations, Table 3 can be generalized as Table 4.

TABLE 4
generalized candidate table

| Link/Band | Channel information | Active AP MLD list/number |
|---|---|---|
| 2.4G | A | 1 |
| | . . . | 2 |
| | C | 3 |
| 5G | . . . | . . . |
| 6G | X | 4 |
| | . . . | . . . |
| | Z | N |

in which each number of 1 to N represents an identifier of an AP MLD, and each letter of A to Z represents an identifier of a channel.

After scanning the channels according to the candidate table 3, the STA MLD 102 may obtain and verify the complete MAC information and/or physical information via an active scanning process using an ML Probe request frame. The ML Probe request frame is sent on the channels which picked up from the candidate table 3.

In some example implementations, according to Wi-Fi 7 11be specification, it introduced the ML Probe process to obtain the whole ML information with each STA profile from an AP MLD. Therefore, the ML Probe process may be used if any AP MLD has the non-complete MLD information in Beacon/ML Probe respond frames.

In some example implementations, if any AP MLD link's working channel has ever been scanned by the STA MLD 102 and the STA MLD 102 has already obtained the full MLD information from beacon/additional ML Probe response, then the corresponding AP MLD entry may be removed from the active AP MLD list on other band/links. In this way, it can reduce the total time for scanning all the channels by the STA MLD 102.

It is to be appreciated that the method and algorithms to select proper scanning parameters are beyond the present disclosure. For the purposed of a continuous description, it is assumed that the scanning channel number selection method may have the active AP MLD number (as shown in Table 3) and scheduling weight as the major factors.

In some example implementations, after obtaining and verifying the complete MAC information and/or physical information of the channels, the STA MLD 102 may double-check the active status of each MLD link by scanning the other links to check if this link actual exists even though the STA MLD 102 can know this MLD link information from the RNR IR or per-STA profile information from an ML probe. This is called a station discovery optimization process.

FIG. 3 illustrates an example diagram 300 of STA MLD discovery optimization for single-radio according to implementations of the present disclosure. As shown in FIG. 3, for a single radio (SR) STA MLD, the SR STA MLD may first group the scanning channel as upper group and lower group as shown in FIG. 3. For example, for the 5 GHz lower band, there are the channel 36, channel 40, channel 44, channel 48, channel 52 and channel 56. For the 5 GHz upper band, there are the channel 149 and channel 153.

In some example implementations, the STA MLD may first scan the channels on the 5 GHz lower band. When the STA MLD receives beacons with MLD parameters in RNR element on channel 44 and channel 52, it then may proceed to the related 5 GHz upper channel to scan the channels (e.g., channel 44 and 149). Since the STA MLD only has one radio so it cannot perform the scanning on the 5 GHz upper band and on the 5 GHz lower band simultaneously, yet it has to first scan channel 149, then back to scan the 5 GHz lower channel 52. By implementing this method, it can reduce the STA MLD scanning channel list. In some ideal cases, for station signal radio case, by scanning half the channel list (either upper or lower), it can obtain all the AP MLD information on this STA MLD.

In some example implementations, for the 5 GHz lower band, the channel 36, the channel 40 and the channel 44 may be grouped into a first group, and the channel 48, the channel 52 and the channel 56 may be grouped into a second group. The scanning process may be first performed on the first group and the channel 44 is discovered. The STA MLD may jump to the 5 GHz upper band to scan the channel 149. After the STA MLD receives the beacons on the channel 149, it may jump to the 5 GHz lower band to scan the channels of the second group.

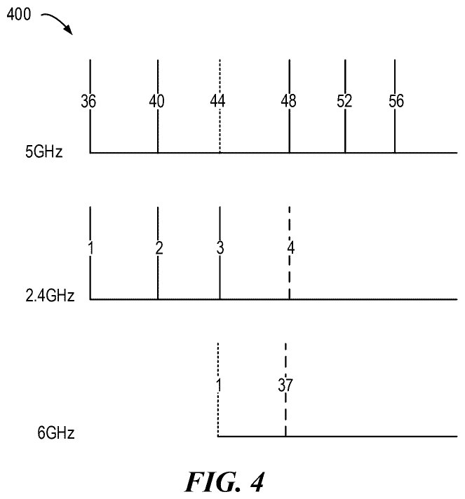

FIG. 4 illustrates an example diagram 400 of STA MLD discovery optimization for multi-radio according to implementations of the present disclosure. As shown in FIG. 4, for a multi radio (MR) STA MLD, the scanning process can also be optimized. For example, taking the case of three-link AP MLD as an example, the STA MLD only needs scan two of the three links. That is, in an actually environment, two-link AP MLD or three-link AP MLD may co-exist, if all of them are needed to be found and not lose a frame, at least it needs to scan two of the three links on STA MLD. Then it can get all the MLD related information.

As an example, by scanning 5 GHz band channel 44, 6 Ghz band channel 1 may be found. By scanning 2.4 GHz band channel 4, 6 Ghz band channel 37 may be found. By using this method, it can avoid unnecessary scanning since 2.4 GHz has a lot of interference, so it can use this method to scan 5G band or 6G band to find 2.4G band information. For each link, active status can be checked. For example, after scanning 5 GHz band channel 44 and 2.4 GHz band channel 4, the STA MLD can scan the 6 Ghz band channel 1 and channel 37 to check whether this link actually exists. For another example, the STA MLD may scan 5 GHz bands and 2.4 GHz and save the scanning for the 6 GHz. That is, the STA MLD may scan any two bands of the 2.4 GHz bands, 5 GHz bands, and 6 GHz bands to discovery all channels on the three frequency bands.

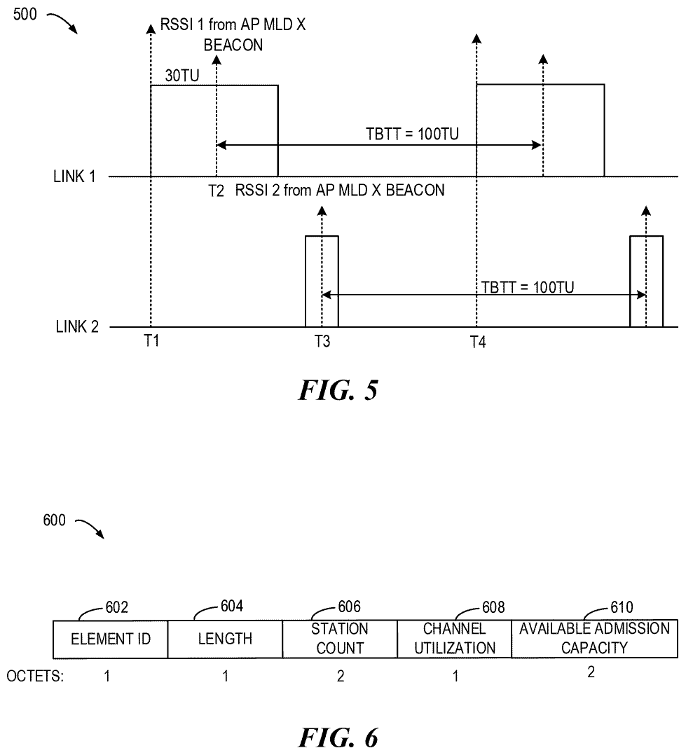

FIG. 5 illustrates an example diagram 500 of obtaining RSSI information via channel scanning according to implementations of the present disclosure. The STA MLD may obtain the RSSI information via a periodic scanning process on per-link for each AP MLD based on the verified active channels. This step may be important and useful for a mobility device requirement due to time sensitivity, and the STA MLD may need to check and obtain the RSSI information for each of active links within a period time (for example, the max value of the TBTT) value from all the links in one AP MLD).

For example, one neighbor AP MLD may have two links, for example, link 1 and link 2, and they use the same TBTT, which is 100 TU time. The periodic scanning time is set to be T=T4−T1=100TU. The RSSI 1 value and RSSI 2 value in each of the periodic scanning time can be obtained. The beacon offset value is set to be the value of T3-T2. That is, it means the scanning start time and dwell time should meet such condition. This design is very useful for the moving AP MLD or the moving STA MLD.

In some implementations, considering the mobility of AP MLD or STA MLDs, the periodic scanning time can be adjusted over time or speeding. For example, the AP MLDs are moving faster than before, the periodic scanning time may be set to be smaller than before. For another example, if the AP MLDs are moving slower than before, the periodic scanning time may be set to be larger than before. As such, the changing of RSSIs over the channels can reflect the changing of the physical location changing of the AP MLDs or STA MLDs.

After obtaining the RSSIs of the active channels on the links of the neighbor AP MLDs, the STA MLD may start to find out the best AP MLD among the neighbor AP MLDs. For example, the STA MLD may compute a path cost for each AP MLD. The STA MLD may connect to the selected AP MLD.

In some example implementations, the path cost can be expressed in formula (1) below:

$${f}_{pathCost} = {\sum }_{i d = 0}^{n} ( Loa d C o s {t}_{id} \cdot {Δ}_{x} + l i n k C o s {t}_{i d} \cdot {Δ}_{y} + ( USHRT\_MAX - {RSSI}_{id} ) \cdot {Δ}_{z} ) \qquad ( 1 )$$

in which f_{pathCost} represents the path cost; id represents the identifier of an AP MLD; LoadCost_{id} represents the load cost of an AP MLD; linkCost_{id} represents the link cost of an AP MLD; USHRT_MAX represents the maximum threshold of the RSSI and usually is set to be 255 dBm; and Δₓ; Δ_{y} and Δ_{z} represents a weight value respectively.

In some example implementations, Δₓ; Δ_{y} and Δ_{z} may be weights needed to adjust with different case. For example, in a roaming case, the STA MLD maybe mainly concern the RSSI. So, in this case, Δ_{z} should have a larger value and other weights, Δₓ and Δ_{y}, should have a smaller value, respectively.

In some example implementations, the load cost may be obtained from a BSS LOAD element from each MLD link. BSS Load is a concept in wireless network management that refers to an element included in the beacon and probe response frames of a Wireless Local Area Network (WLAN), which describes the load situation of the BSS. The BSS is a collection of all devices in a wireless network that communicate through an AP or AP MLD.

The BSS LOAD element may indicate the STA count, channel utility and available admission capacity on this link. For example, reference is made to FIG. 6, which illustrates an example BSS load element format 600. As shown in FIG. 6, the BSS load element format 600 may occupy seven octets. Block 602 represents a field of an element ID and it occupies 1 octet. Block 604 represents a field of a length of the BSS load element frame and it occupies 1 octet.

Block 606 represents a field of a station count and it occupies 2 octets. The station count represents the number of clients currently associated with the BSS LOAD element. Block 608 represents a field of a channel utilization and it occupies 1 octet. The channel utilization represents the percentage of time when the channel is busy, and thus it indicates the level of channel congestion. Block 610 represents a field of an available admission capacity and it occupies 2 octets. The available admission capacity represents a metric within the BSS LOAD element of a WLAN that indicates the amount of additional client traffic that the BSS can accommodate within a second. Therefore, with the available admission capacity, the information on how congested the wireless network is and how many more clients can be admitted without degrading service quality can be known.

From the BSS load element as shown in FIG. 6, the STA MLD can compute each load cost of each AP MLD and use them to determine the path cost. In some example implementations, the link cost may refer to the capability of an STA MLD compared with the capability of an AP MLD. The link cost can be expressed in formula (2) below:

$$LinkCost = Cov ( \frac{STA MLD ( bw )}{AP MLD ( bw )} , \frac{STA MLD ( nss )}{AP MLD ( nss )} , … ) \qquad ( 2 )$$

in which (bw) represents a bandwidth, (nss) represents a number of spatial streams; . . . represents that other parameters may also be added into formula (2), such as the extremely high throughput (ETH) and modulation and coding scheme (MCS), and so on; and Cov( ) represents a covariance operation.

By formula (2), the covariance of the MAC and/or physical capability between a STA MLD and an AP MLD can be computed as the link cost. For example, if AP MLD capability>STA MLD capability, it will mark STA MLD=AP MLD since AP capability can cover STA capability.

In some example implementations, if the capability of STA MLD=the capability of AP MLD, it means they have the same capabilities of NSS, BW, and/or MCS, then the finial link cost should be 1. In some example implementations, if the capability of STA MLD<the capability of AP MLD, for example, the AP MLD supports 80 MHz bandwidth and the STA MLD only supports 40 MHz, it also be fine as mentioned above, the finial link cost should also be 1. In some example implementations, if the capability of AP MLD<the capability of STA MLD, then the finial link cost should be greater than 1, since this AP MLD cannot let the STA MLD use its best capability to establish a link between them, so this neighbor AP MLD should have a large link cost.

It is to be understood that all these above-mentioned parameters are used to find out a best neighbor AP MLD that has the lowest path cost. Thus, other parameters which are not mentioned herein can also be added without limitation.

Then after computing each path cost of each AP MLD, the STA MLD can use a simple formula to find out the finial best neighbor AP MLD which has the lowest path cost. For example, formula (3) can be used to the AP MLD with the lowest path cost.

$$AP MLD with the lowest path cost = MIN ( {f}_{pathCost} ) \qquad ( 3 )$$

in which MIN( ) represents a function of determining the minimum value and returns its corresponding object.

For example, referring back to FIG. 1, the load cost for the link 110 may be determined as a value of 10, and the weight for the load cost may be 0.3. The link cost for the link 110 may be determined as a value of 20, and the weight for the link cost may be 0.2. The RSSI for the link 110 may be a value of −50 dbm, and the weight for the RSSI may be 0.5. Because the AP MLD 104 has only one link, i.e., the link 110, then the path cost for the AP MLD 104 only depends on the link 110. The path cost for the AP MLD 104 can be computed as 10×0.3+20×0.2+(255−(−50))×0.5=3+4+152.5=159.5. Similarly, the path cost for the AP MLD 106 and the path cost for the AP MLD 108 can be computed in a similar manner. Assuming the path cost for the AP MLD is 150 and the path cost for the AP MLD 108 is 140. Then, the STA MLD 102 may compare the three values of the path cost and may determine that the lowest value is 140, which corresponds to the AP MLD 108. Therefore, the STA MLD 102 may determine that AP MLD 102 is the AP MLD with the lowest path cost. The STA MLD 102 may select the AP MLD 108 to connect with.

With the above process as described with reference to FIG. 1 to FIG. 6, the STA MLD can determine a candidate AP MLD with the best performance based on the scanning result. The process assess the neighbor AP MLDs considers the MAC information, the physical information, and the RSSI information, thus the assessment result is much more comprehensive than the traditional assessment. The assessment result is much more accurate and more effective. Further, the channel discovery strategy for a STA MLD is more efficient, and thus the time for scanning the channels can be saved.

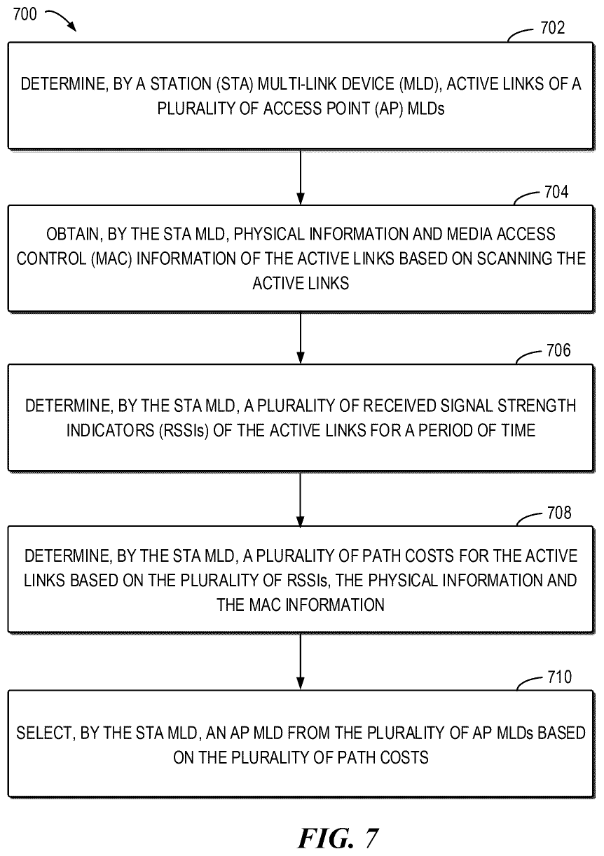

Reference is made to FIG. 7, which illustrates an example flow chart of an example method 700 for selecting an AP according to implementations of the present disclosure, and the method 700 may be performed by a STA MLD such as the STA MLD 102. For clarity, reference will be made in combination with FIG. 1.

At 702, the STA MLD 102 determines active links of a plurality of access point (AP) MLDs. As an example, the STA MLD 102 may determine the link 110, the link 112, the link 114, the link 116, the link 118, and the link 120 as the active links of the AP MLD 104, the AP MLD 106 and the AP MLD 108.

At 704, the STA MLD 102 obtains physical information and MAC information of the active links based on scanning the active links. For example, the STA MLD 102 may scan the link 110 and may obtain the physical information and MAC information of the link 110. Similarly, the STA MLD 102 may scan the link 112 and may obtain the physical information and MAC information of the link 112. The STA MLD 102 may scan other links and may obtain their physical information and MAC information, respectively. In some example implementations, the STA MLD 102 may cross check the scanning results by scanning other links.

At 706, the STA MLD 102 determines a plurality of RSSIs of the active links for a period of time. For example, the period of time for link 110 of the AP MLD 104 may be 100 milliseconds (ms) and STA MLD 102 may determine the RSSI of the link 110 during 100 ms. For another example, the period of time for link 112 of the AP MLD 106 may be 80 ms, and the period of time for link 114 of the AP MLD 106 may be 100 ms, and period of time for link 116 of the AP MLD 106 may be 120 ms, then STA MLD 102 may determine the final RSSI of the AP MLD 106 during 120 ms, because 120 ms is the maximum of the TBTT values from all the links of the AP MLD 106.

At 708, the STA MLD 102 determines a plurality of path costs for the active links based on the plurality of RSSIs, the physical information, and the MAC information. For example, the STA MLD 102 may use the RSSIs of the link 110, and the physical information, and the MAC information to compute the path cost of the link 110.

At 710, the STA MLD 102 selects an AP MLD from the plurality of AP MLDs based on the plurality of path costs. For example, the STA MLD may compute each path cost of each link, and may compute each final path cost of each AP MLD based on the formulas (1) to (3). If the final path cost of the AP MLD 106 is the smallest among the AP MLD 104, the AP MLD 106, and the AP MLD 108, the STA MLD 102 may select the APMLD 106 as the AP MLD with the best performance and will connect to the AP MLD 106.

According to implementations of the present disclosure, the STA MLD can be capable of identifying the most high-performing candidate AP MLD by analyzing the scan results among the neighbor AP MLDs. This evaluation process can consider the MAC details, physical characteristics, and RSSI data of the neighbor AP MLDs, and thus making it far more comprehensive than traditional assessments. Consequently, the outcome is not only more accurate but also more efficient. Additionally, the channel discovery strategy employed by the STA MLD is more effective, and thus allowing for a reduction in the time spent on channel scanning.

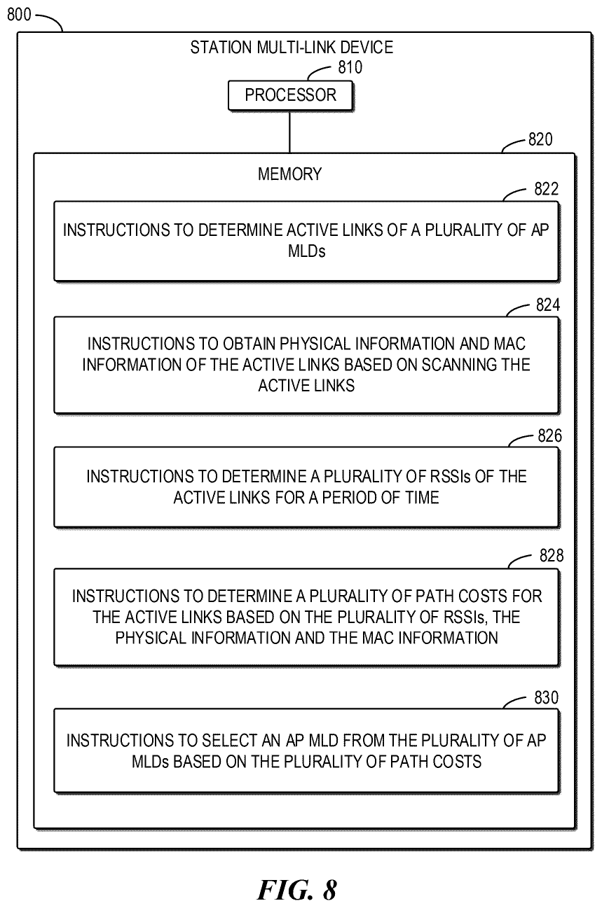

Reference is made to FIG. 8, which illustrates an example STA MLD 800 according to implementations of the present disclosure. As shown in FIG. 8, the STA MLD 800 comprises at least one processor 810, and a memory 820 coupled to the at least one processor 810. The memory 820 stores instructions 822, 824, 826, 828, and 830 to cause the processor 810 to perform actions according to example implementations of the present disclosure. As shown in FIG. 8, the memory 820 stores instructions 822 to determine active links of a plurality of AP MLDs. The memory 820 further stores instructions 824 to obtain physical information and MAC information of the active links based on scanning the active links.

The memory 820 further stores instructions 826 to determine a plurality of RSSIs of the active links for a period of time. The memory 820 further stores instructions 828 to determine a plurality of path costs for the active links based on the plurality of RSSIs, the physical information and the MAC information. The memory 820 further stores instructions 830 to select an AP MLD from the plurality of AP MLDs based on the plurality of path costs. The stored instructions and the functions that the instructions may perform can be understood with reference to the description of FIGS. 2-7. For the purpose of simplification, the details of instructions 822, 824, 826, 828, and 830 will not be discussed herein.

Similarly, by implementing the instructions 822, 824, 826, 828, and 830, the AP MLD quality assessment approach and the evaluation model can be enhanced, and thus it can improve the efficiency and accuracy of an STA MLD to evaluate the quality of neighbor AP MLDs. Other advantages of implementations will not be discussed again for the sake of simplification.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
determining, by a station (STA) multi-link device (MLD), active links of a plurality of access point (AP) MLDs;
obtaining, by the STA MLD, physical information and media access control (MAC) information of the active links based on scanning the active links;
determining, by the STA MLD, a plurality of received signal strength indicators (RSSIs) of the active links for a period of time;
determining, by the STA MLD, a plurality of path costs for the active links based on the plurality of RSSIs, the physical information, and the MAC information; and
selecting, by the STA MLD, an AP MLD from the plurality of AP MLDs based on the plurality of path costs.

2. The method of claim 1, wherein determining the active links of the plurality of AP MLDs comprises:
receiving, by the STA MLD, a plurality of frames for a beacon response or a probe response; and
determining, by the STA MLD, at least one of the following:
MLD parameters in reduced neighbor report (RNR) information element (IE) included in the plurality of frames; or
per-STA profile information in multi-link (ML) IE included in the plurality of frames.

3. The method of claim 1, further comprising:
listening beacons or probes on the active links; and
determining a candidate table for scanning a plurality of channels of the active links based on a result of the listening, and wherein the candidate table indicates a link, corresponding channels associated with the link and corresponding AP MLDs associated with the link.

4. The method of claim 3, further comprising:
scanning the plurality of channels of the active links based on the candidate table to obtain additional beacon responses or additional probe responses, and
obtaining additional information of the physical information and the MAC information based on the additional beacon responses or the additional probe responses.

5. The method of claim 4, wherein obtaining the physical information and the MAC information of the active links based on scanning the active links comprises:
obtaining the physical information and the MAC information of the active links based further on the additional beacon responses or the additional probe responses.

6. The method of claim 1, wherein the physical information and the MAC information comprises at least one of:
at least one frequency band;
at least one channel number;
at least one dwell time; or
at least one scanning time.

7. The method of claim 1, wherein scanning the active links comprises:
identifying a plurality of channels on the active links to obtain a channel list for scanning;
identifying the plurality of channels as a plurality of groups based on the channel list;
scanning a portion of the plurality of groups; and
determining a result of the scanning based on a result of scanning the portion of the plurality of groups.

8. The method of claim 1, wherein determining the plurality of RSSIs of the active links for the period of time comprises:
determining a plurality of target beacon transmission time (TBTT) values from a plurality of links on an AP MLD of the plurality of the AP MLDs; and
determining the period of time for the AP MLD of the plurality of the AP MLDs based on the TBTT values.

9. The method of claim 2, wherein determining the plurality of path costs for the active links based on the plurality of RSSIs, the physical information, and the MAC information comprises:
determining, by the STA MLD, a plurality of load costs based on basic service set (BSS) load elements included in the plurality of frames;
determining, by the STA MLD, a plurality of link costs based on capabilities of the plurality of AP MLDs and a capability of the STA MLD; and
determining the plurality of path costs for the active links based on the plurality of RSSIs, the plurality of load costs, and the plurality of link costs.

10. The method of claim 9, wherein the capabilities of the plurality of AP MLDs and the capability of the STA MLD comprises at least one of the following:
at least one bandwidth;
at least one number of spatial streams;
at least one extremely high throughput; or
at least one modulation and coding scheme.

11. A station (STA) multi-link device (MLD) comprising:
at least one processor; and
a memory coupled to the at least one processor, the memory storing instructions to cause the at least one processor to:
determine active links of a plurality of access point (AP) MLDs;
obtain physical information and media access control (MAC) information of the active links based on scanning the active links;
determine a plurality of received signal strength indicators (RSSIs) of the active links for a period of time;
determine a plurality of path costs for the active links based on the plurality of RSSIs, the physical information, and the MAC information; and
select an AP MLD from the plurality of AP MLDs based on the plurality of path costs.

12. The STA MLD of claim 11, wherein the instructions to determine the active links of the plurality of AP MLDs comprise instructions to cause the at least one processor to:
receive a plurality of frames for a beacon response or a probe response; and
determine at least one of the following:
MLD parameters in reduced neighbor report (RNR) information element (IE) included in the plurality of frames; or
per-STA profile information in multi-link (ML) IE included in the plurality of frames.

13. The STA MLD of claim 11, further comprising instructions to cause the at least one processor to:
listen beacons or probes on the active links; and
determine a candidate table for scanning a plurality of channels of the active links based on a result of the listening, and wherein the candidate table indicates a link, corresponding channels associated with the link and corresponding AP MLDs associated with the link.

14. The STA MLD of claim 13, further comprising instructions to cause the at least one processor to:
scan the plurality of channels of the active links based on the candidate table to obtain additional beacon responses or additional probe responses, and
obtain additional information of the physical information and the MAC information based on the additional beacon responses or the additional probe responses.

15. The STA MLD of claim 14, wherein the instructions to obtain the physical information and the MAC information of the active links based on scanning the active links comprise instructions to cause the at least one processor to:
obtain the physical information and the MAC information of the active links based further on the additional beacon responses or the additional probe responses.

16. The STA MLD of claim 11, wherein the physical information and the MAC information comprises at least one of:
at least one frequency band;
at least one channel number;
at least one dwell time; or
at least one scanning time.

17. The STA MLD of claim 11, wherein the instructions to scan the active links comprise instructions to cause the at least one processor to:
identify a plurality of channels on the active links to obtain a channel list for scanning;
identify the plurality of channels as a plurality of groups based on the channel list;
scan a portion of the plurality of groups; and
determine a result of the scanning based on a result of scanning the portion of the plurality of groups.

18. The STA MLD of claim 11, wherein the instructions to determine the plurality of RSSIs of the active links for the period of time comprise instructions to cause the at least one processor to:
determine a plurality of target beacon transmission time (TBTT) values from a plurality of links on an AP MLD of the plurality of the AP MLDs; and
determine the period of time for the AP MLD of the plurality of the AP MLDs based on the TBTT values.

19. The STA MLD of claim 12, wherein the instructions to determine the plurality of path costs for the active links based on the plurality of RSSIs, the physical information, and the MAC information comprise instructions to cause the at least one processor to:
determine a plurality of load costs based on basic service set (BSS) load elements included in the plurality of frames;
determine a plurality of link costs based on capabilities of the plurality of AP MLDs and a capability of the STA MLD, wherein the capabilities of the plurality of AP MLDs and the capability of the STA MLD comprises at least one of the following: at least one bandwidth; at least one number of spatial streams; at least one extremely high throughput; or at least one modulation and coding scheme; and
determine the plurality of path costs for the active links based on the plurality of RSSIs, the plurality of load costs, and the plurality of link costs.

20. A non-transitory computer-readable medium comprising instructions stored thereon which, when executed by a station (STA) multi-link device (MLD), cause the STA MLD to:
determine active links of a plurality of access point (AP) MLDs;
obtain physical information and media access control (MAC) information of the active links based on scanning the active links;
determine a plurality of received signal strength indicators (RSSIs) of the active links for a period of time;
determine a plurality of path costs for the active links based on the plurality of RSSIs, the physical information, and the MAC information; and
select an AP MLD from the plurality of AP MLDs based on the plurality of path costs.
